(19) United States
(12) Patent Application Publication
(10) Pub. No.: US 2008/0073927 A1
(43) Pub. Date: Mar. 27, 2008

(54) Vehicle trim component storage compartment and method of making same

(75) Inventors: Michael P. Schoemann, Waterford, MI (US); Tracy L. Simpson, Portland, OR (US); Richard D. George, Rochester Hills, MI (US); David Michael Failla, Lake Orion, MI (US); Herb Stables, Pontiac, MI (US); John L. Adams, Warren, MI (US); Steve Gage, Utica, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: Lear Corporation

(21) Appl. No.: 11/525,437

(22) Filed: Sep. 22, 2006

(51) Int. Cl. B60R 7/00

(52) U.S. Cl. 296/37.1

(57) ABSTRACT

A vehicle trim component includes a substrate defining at least one wall of a storage compartment. The substrate has an edge surface which defines an opening into the storage compartment. A semi-rigid member extends outward of the edge surface and at least partially covers the opening to define a storage compartment closure. The semi-rigid member is manually deflectable between a closed position and an open position.

### BACKGROUND

Various embodiments of a vehicle trim component are described herein. In particular, the embodiments described herein relate to an improved vehicle trim component having a storage compartment and a method of manufacturing such an improved vehicle trim component.

The interior of the vehicle includes a multitude of components for covering various frameworks, instruments, and electrical devices mounted within the interior compartment of a vehicle. Examples of trim components include instrument panels, door panels, center consoles, overhead consoles, and other various interior panels for covering the sides, ceilings, and vertical pillars of the frame members of the vehicle.

A trim component, such as an instrument panel, is generally made of plastic and commonly has rigid exterior surfaces facing the interior of the vehicle. The trim components may include open storage bins, or storage bins with relatively expensive covers or doors.

For example, U.S. Pat. No. 5,810,414 discloses a storage receptacle for storing objects in a vehicle space, such as a dashboard, U.S. Pat. No. 6,932,402 discloses a console box having a sliding cover defining an armrest, and Japan Patent No. 9-193952 discloses a console box with an armrest that functions as a lid.

### SUMMARY

The present application describes various embodiments of a vehicle trim component and its method of manufacture. One embodiment of the vehicle trim component includes a substrate defining at least one wall of a storage compartment. The substrate has an edge surface which defines an opening into the storage compartment. A semi-rigid member extends outward of the edge surface and at least partially covers the opening to define a storage compartment closure. The semi-rigid member is manually deflectable between a closed position and an open position.

A method of manufacturing a vehicle trim component includes forming a substrate within a mold assembly. The substrate is formed from a first material and defines at least one wall of a storage compartment. The substrate further has an edge surface which defines an opening into the storage compartment. A semi-rigid member is then formed within the mold assembly. The semi-rigid member is formed from a second material different from the first material and extends outward of the edge surface such that it at least partially covers the opening. The semi-rigid member is manually deflectable between a closed position and an open position and defines a storage compartment closure.

Other advantages of the vehicle trim component storage compartment and its method of manufacture will become apparent to those skilled in the art from the following detailed description, when read in light of the accompanying drawings.

### BRIEF DESCRIPTION OF THE DRAWINGS

FIG. 1 is a schematic perspective view of a vehicle door panel illustrating first and second embodiments of the trim component storage compartment closure.

FIG. 2 is a partial cross sectional view of the vehicle door panel taken along line 2-2 of FIG. 1.

FIG. 3 is a schematic perspective view of a vertical vehicle pillar illustrating a third embodiment of the trim component storage compartment closure.

FIG. 4 is a cross sectional view in elevation of a mold assembly illustrating a step of a first embodiment of a method of manufacturing the third embodiment of the trim component storage compartment closure.

FIG. 5 is a cross sectional view in elevation of another mold assembly illustrating another step in the first embodiment of the method of manufacturing the trim component storage compartment closure illustrated in FIG. 4.

FIG. 6 is a cross sectional view in elevation of a mold assembly illustrating a step of a second embodiment of a method of manufacturing the third embodiment of the trim component storage compartment closure.

FIG. 7 is a cross sectional view in elevation of another mold assembly illustrating another step in the second embodiment of the method of manufacturing the trim component storage compartment closure illustrated in FIG. 6.

FIG. 8 is a cross sectional view in elevation of a fourth embodiment of the trim component storage compartment closure.

FIG. 9 is a cross sectional view in elevation of a portion of a fifth embodiment of the trim component storage compartment closure.

### DETAILED DESCRIPTION

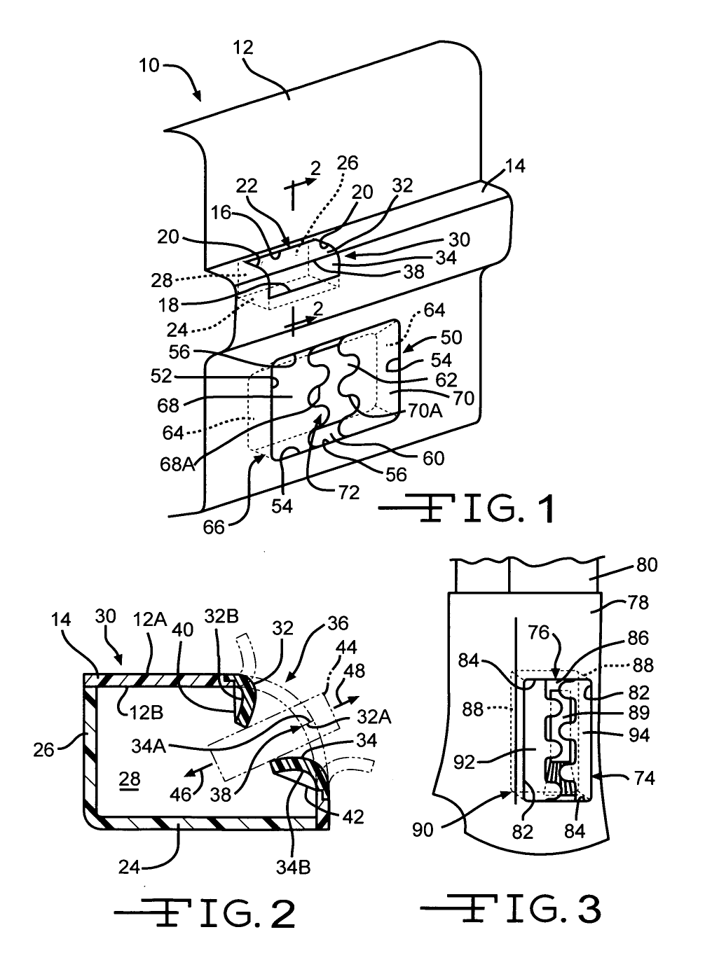

Referring now to the drawings, there is illustrated in FIG. 1 a vehicle door panel, indicated generally at 10. The illustrated door panel 10 is an example of a vehicle trim component for mounting in an interior cabin of a vehicle. It will be understood that the structure and method of manufacturing a trim component described and shown in FIGS. 1 and 2 are with respect to the door panel 10. However, the structure and method may be practiced to form any type of trim component or portions of trim components. Examples of other such trim components which can be formed having the storage compartment closure described herein and which can be formed according to the method described herein include instrument panels, center consoles, overhead consoles, and other interior panels for covering the sides, ceilings, and/or vertical pillars of the vehicle.

The door panel 10 illustrated in FIG. 1 includes a substrate 12. The substrate 12 is formed having a predetermined external contour. In the illustrated embodiment, the substrate 12 has a contour defining an armrest 14. The armrest 14 has a first inner edge surface 16, a second inner edge surface 18, and a pair of opposing third edge surfaces 20 extending between the first and second edge surfaces 16 and 18. The edge surfaces 16, 18, and 20 define an opening 22. The armrest 14 further includes a bottom wall 24, a rear wall 26, and a pair of opposing side walls 28. The walls 24, 26, and 28, and the opening 22 define a first storage compartment 30.

Referring now to the exemplary embodiment illustrated in FIG. 2, the armrest 14 of the door panel 10 is shown in cross-section. It will be understood that the molding process described herein below may be applied to the entire door panel 10, or to any other type of trim component or portions of trim components. In the illustrated embodiment, a first or A-side surface 12A of the substrate 12 will face the interior cabin of the vehicle. A second or B-side surface 12B of the substrate 12 will face away from the interior cabin of the vehicle. Although not illustrated, it will be understood that the A-side surface 12A may include an outer layer visible to a vehicle occupant. Such an outer layer may be formed from a material softer than the material of the substrate 12 (as will be described in detail below), such that the outer layer is tactilely soft relative to the substrate 12. The outer layer may also have any desired texture and color.

In the embodiment illustrated in FIG. 2, a first flexible or cover member 32 is attached to the first inner edge surface 16 within the opening 22. A second flexible or cover member 34 is attached to the second inner edge surface 18 within the opening 22. The first and second cover members 32 and 34 define a first embodiment of a semi-rigid member or a storage compartment closure 36. The first and second cover members 32 and 34 extend inwardly over the opening 22 such that an inner edge 32A of the first cover member 32 and an inner edge 34A of the second cover member 34 are aligned to define a closure seam 38.

In the exemplary embodiment illustrated in FIGS. 1 and 2, the opening 22 is substantially rectangular-shaped. It will be understood however, that the opening 22 can have any desired shape, such as, for example, a substantially oval shape, or any other desired polygonal shape.

The illustrated inner edges 32A and 34A are substantially straight and are substantially adjacent to one another. It will be understood however, that the inner edges 32A and 34A may have any desired shape, such as a serpentine shape as illustrated in the second closure 72, described in detail below.

The illustrated storage compartment closure 36 is formed having a predetermined external contour. In the illustrated embodiment, the closure 36 has a contour corresponding to the contour of the armrest 14 and defining a closed position, as best shown in FIG. 1. The B-side surfaces 32B and 34B (i.e., the surfaces facing away from the interior cabin of the vehicle) of the first and second cover members 32 and 34 include at least one strengthening or reinforcing rib 40 and 42, respectively.

The illustrated storage compartment closure 36 is substantially flexible or manually deflectable. As used herein, substantially flexible or manually deflectable is defined as manually movable from the closed position, as shown in FIG. 1, to an open position, as shown generally at 36′ and 36″ in FIG. 2, upon application of a force by a vehicle occupant. Such a force may be applied when inserting or removing an object (shown by the phantom line 44 in FIG. 2) into or from the first storage compartment 30. In the illustrated embodiment, the portion of the first and second cover members 32 and 34 adjacent the first and second edge surfaces, 16 and 18, respectively, define a living hinge.

As best shown in FIG. 2, the living hinge allows the first and/or second cover members 32 and 34 to be displaced inwardly (in the direction of the arrow 46), or outwardly (in the direction of the arrow 48). For example, a vehicle occupant may desire to store a map, a flashlight, or any other object within the first storage compartment 30. Such a manually deflectable closure 36 then resiliently returns, in a spring-like manner, to the closed position (and thereby to the predetermined exterior contour) upon removal of the applied force and without permanent deformation of the closure 36. The manually deflectable closure 36 allows the vehicle occupant easy access to the first storage compartment 30, and provides an efficient, easy to manufacture, and inexpensive cover or closure 36 for the storage compartment 30.

In the illustrated embodiment, the first and second cover members 32 and 34 are integrally molded within the opening 20 according to the method described in detail herein below.

The door panel 10 illustrated in FIG. 1 also includes a second embodiment of the trim component storage compartment closure. As shown in FIG. 1, the door panel 10 includes a second storage compartment or map pocket 50. The map pocket 50 has a first inner edge surface 52, a second inner edge surface 54, and a pair of opposing third inner edge surfaces 56 extending between the first and second edge surfaces 52 and 54. The edge surfaces 52, 54, and 56 define an opening 58. The map pocket 50 further includes a bottom wall 60, a rear wall 62, and a pair of opposing side walls 64. The walls 60, 62, and 64, and the opening 58 define a second storage compartment 66.

In the illustrated embodiment, a third cover member 68 is attached to the first inner edge surface 52 within the opening 58. A fourth cover member 70 is attached to the second inner edge surface 54 within the opening 58. The third and fourth cover members 68 and 70 define a second embodiment of the storage compartment closure 72. The third and fourth cover members 68 and 70 extend inwardly over the opening 58 such that an inner edge 68A of the third cover member 68 and an inner edge 70A of the fourth cover member 70 are spaced apart. If desired, a portion of the illustrated third and/or the fourth cover members 68 and 70 may be attached to one or both of the pair of third inner edge surfaces 56.

Although not illustrated, it will be understood that the third and fourth cover members 68 and 70 of the second storage compartment closure 72 may be displaced inwardly and outwardly upon application of a force, such as shown in FIG. 2 and described in detail herein above.

In the illustrated embodiment, the third and fourth cover members 68 and 70 are integrally molded within the opening 20 according to the method described in detail herein below.

The inner edges 68A and 70A illustrated in FIG. 1 have a substantially serpentine shape. It will be understood however, that the inner edges 68A and 70A may have any desired shape, such as substantially straight, and may be substantially adjacent to one another, such as illustrated by the first closure 36.

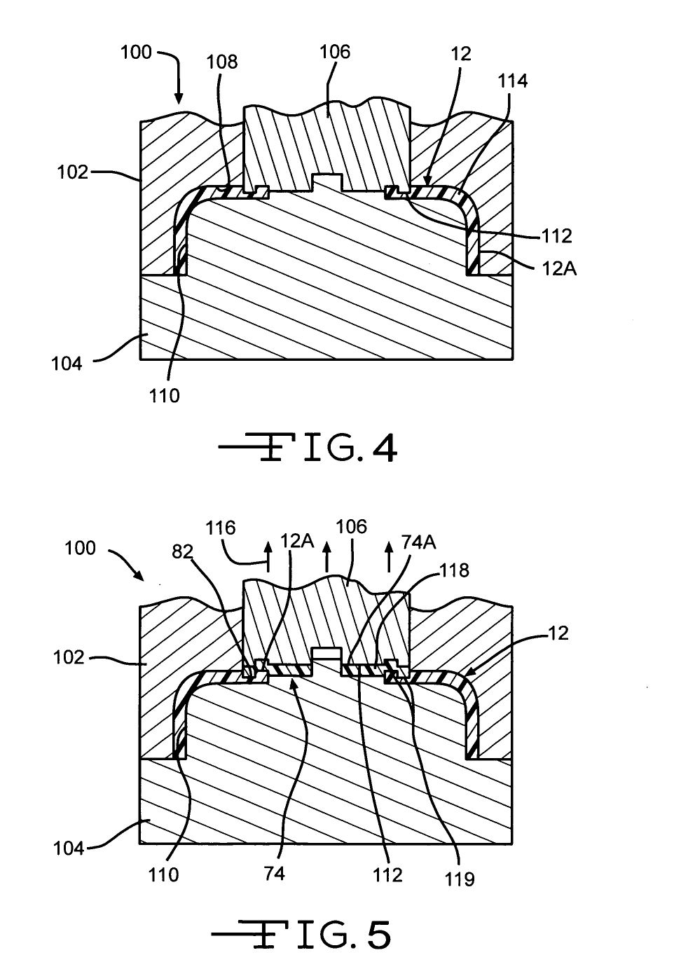

Referring now to FIG. 3, a third embodiment of the trim component storage compartment closure 74 is shown in cooperation with a storage compartment 76 of a pillar cover 78 for a vertical pillar, such as a commonly known as a B-pillar 80. Alternatively, the closure 74 may be formed in cooperation with a pillar cover of a C-pillar or any other desired trim panel. As shown in FIG. 3, the pillar cover 78 includes inner edge surfaces 82 and 84 defining an opening 86. The pillar cover 78 may also include a plurality of walls 88, such that the walls 88 and the opening 86 define a third storage compartment 90, for the storage of an object such as a flashlight 89, a window scraper, a map, and the like. The illustrated closure 74 is substantially identical to the closure 72 and will not be described in detail herein. The closure 74 includes cover members 92 and 94 attached to the inner edge surfaces 82 within the opening 86.

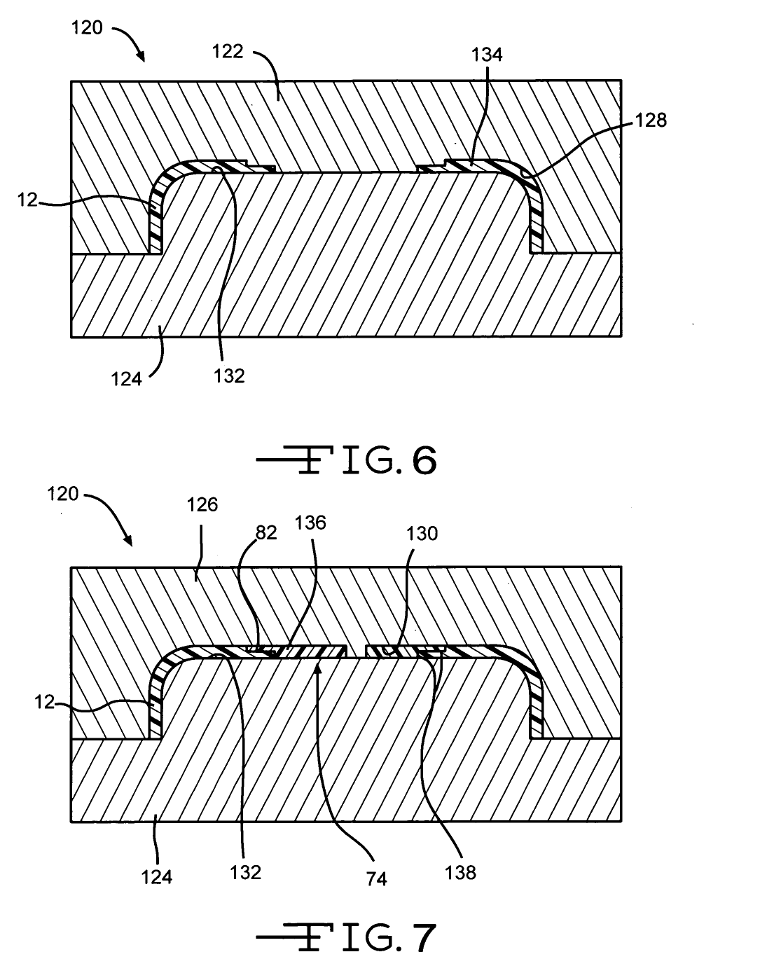

A vehicle trim component, such as the pillar cover 78 of the B-pillar 80 illustrated in FIG. 3, may be manufactured by a two step molding process, as schematically illustrated in FIGS. 4 through 7. In the exemplary embodiment illustrated in FIGS. 4 and 5, a first mold assembly 100 includes a first mold portion or cavity 102 movably mounted relative to a second mold portion or core 104. The illustrated cavity 102 includes a movable cavity 106. The illustrated cavity, core, and movable cavity 102, 104, and 106 include contour surfaces 108, 110, and 112, respectively. The contour surfaces 108 and 112 face the contour surface 110 in a spaced apart relationship and define a first mold cavity 114 therebetween. The first mold cavity 114 generally corresponds to the shape and the dimensions of the substrate 12 (in FIG. 4, the first mold cavity 114 is shown with the substrate 12 therein).

A first step of a first embodiment of the method of manufacturing the trim component closure is illustrated in FIGS. 4 and 5. For illustrative purposes only, the third embodiment of the trim component storage compartment closure 74 is shown in FIGS. 4 and 5, however the method described may be used to form any embodiment of the trim component storage compartment closure. In the illustrated embodiment, the cavity 102 and the core 104 are moved together to a first position, as shown in FIG. 4. A first material is then introduced into the first mold cavity 114 to form the substrate 12. The first material is introduced into the first mold cavity 114 in a liquefied form, conforms to the shape of the first mold cavity 114, and is partially or completely cooled and/or cured to form the substrate 12.

The first material of the substrate 12 may be any desired substantially rigid material, such as a polymer or plastic. Examples of materials suitable for the substrate 12 include polypropylene, thermoplastic elastomer (TPE), thermoplastic elastomer polyolefin, polycarbonate, acrylonitrile butadiene styrene (ABS), polycarbonate ABS, styrene maleic anhydride (SMA), polyphenylene oxide (PPO), nylon, polyester, acrylic, and polysulfone. It will be understood that the A-side surface 12A of the substrate 12 may have any desired texture and color.

A second step of the first embodiment of the method of manufacturing the trim component closure 74 is illustrated in FIG. 5. In the second step, the movable cavity 106 is moved upwardly (as viewed in FIG. 5 and in the direction of the arrow 116) to create a second mold cavity 118 between the contour surface 112 of the moveable cavity 106, the contour surface 110 of the core 104, and an A-side surface 12A of the substrate 12. The second mold cavity 118 generally corresponds to the shape and the dimensions of the closure 74. A second material is then introduced into the second mold cavity 118 in a liquefied form, conforms to the shape of the second mold cavity 118, and is partially or completely cooled and/or cured to form the closure 74.

As illustrated in FIG. 5, the substrate 12 remains in the mold assembly 100 during the second step. The second material is then introduced into the second mold cavity 118 to form the closure 74 such that edge surfaces 119 of the closure 74 are chemically bonded with the inner edge surfaces 82 of the substrate 12.

The second material of the closure 74 may be any desired flexible or semi-rigid material, such as such as TPE, thermoplastic elastomer-ether-ester (TEEE), or ethylene propylene diene monomer (EPDM). It will be understood that any other desired materials, such as other elastomers and non-elastomers, may be used. It will be understood that an A-side surface 74A of the closure 74 may have any desired texture and color.

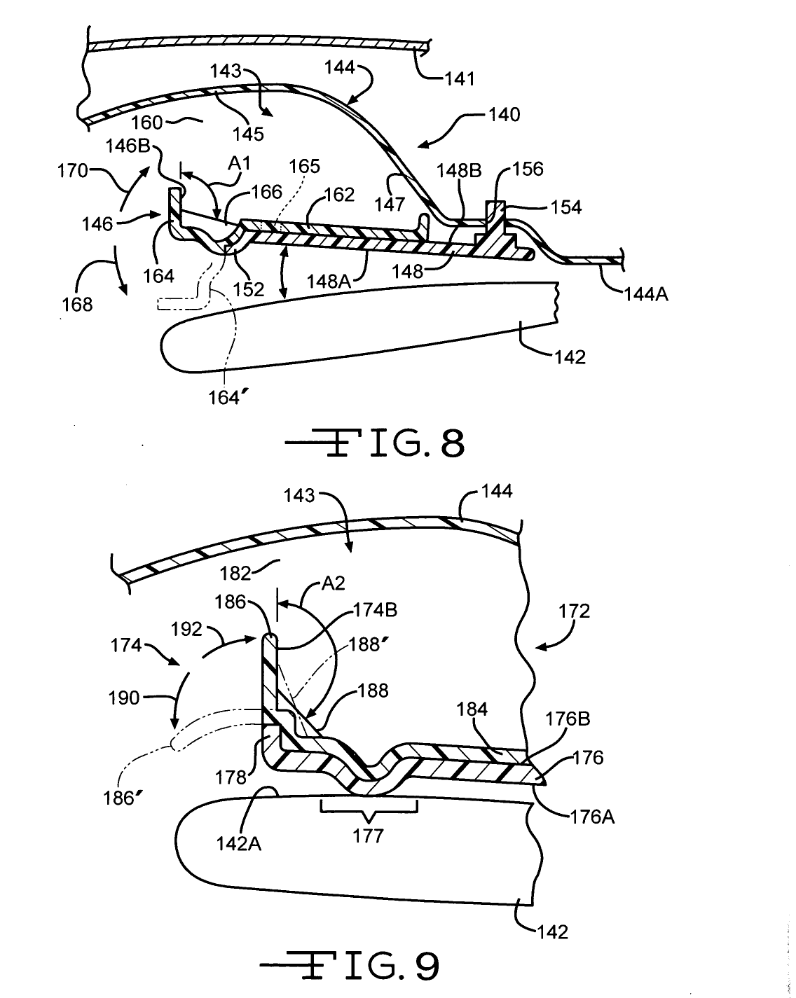

In the exemplary embodiment illustrated in FIGS. 6 and 7, a second mold assembly 120 includes a first mold portion or first cavity 122 movably mounted relative to a second mold portion or core 124, and a second cavity 126 movably mounted relative to the core 124. The illustrated first cavity 122, second cavity 126, and core 124 include contour surfaces 128, 130, and 132, respectively. The contour surfaces 128 and 132 face one another in a spaced apart relationship and define a first mold cavity 134 therebetween. Similarly, contour surfaces 130 and 132 face one another in a spaced apart relationship and define a second mold cavity 136 therebetween. The first mold cavity 134 generally corresponds to the shape and the dimensions of the substrate 12 (in FIG. 6, the first mold cavity 134 is shown with the substrate 12 therein).

A first step of a second embodiment of the method of manufacturing the trim component closure is illustrated in FIGS. 6 and 7. In the illustrated embodiment, the cavity 122 and the core 124 are moved together to a first position, as shown in FIG. 6. The first material is then introduced into the first mold cavity 134 to form the substrate 12. The first material is introduced into the first mold cavity 134 in a liquefied form, conforms to the shape of the first mold cavity 134, and is partially or completely cooled and/or cured to form the substrate 12.

A second step of the second embodiment of the method of manufacturing the trim component closure 74 is illustrated in FIG. 7. In the second step, the first cavity 122 may be moved away from the core 124, and the second cavity 126 is generally positioned in its place and defines the second mold cavity 136, as best shown in FIG. 7. The second mold cavity 136 generally corresponds to the shape and the dimensions of the closure 74 (in FIG. 7, the second mold cavity 136 is shown with the closure 74 therein). The second material is then introduced into the second mold cavity 136 in a liquefied form, conforms to the shape of the second mold cavity 136, and is partially or completely cooled and/or cured to form the closure 74.

As illustrated in FIG. 7, the substrate 12 remains in the core 124 during the second step. The second material is then introduced into the second mold cavity 136 to form the closure 74 such that edge surfaces 138 of the closure 74 are chemically bonded with the inner edge surfaces 82 of the substrate 12.

In FIGS. 4 through 7, two methods of manufacturing the trim component storage compartment closure using a two-shot molding process are illustrated. Alternatively, two separate molds (not shown) could be used sequentially to form the substrate 12 and the closure 74.

It will be also be understood, that the method of forming the trim component and trim component storage compartment closure may be satisfactorily performed wherein the manually deflectable closure, such as the closure 74, is formed prior to the substrate 12.

Referring now to FIG. 8, there is illustrated an elevational view in section of a fourth embodiment of the storage compartment, indicated generally at 140. The storage compartment 140 is shown formed between a visor 142 and the vehicle overhead substrate or headliner 144 (shown adjacent a vehicle roof 141). It will be understood that the fourth embodiment of the storage compartment 140 may be formed at any other desired location within the vehicle.

In the illustrated embodiment, the storage compartment 140 includes a recess 143 is formed in the headliner 144 and defines a first or upper wall 145, and three contiguous side walls, of which only a rear wall 147 (to the right as viewed in FIG. 8) is illustrated. A substrate 148 defines a bottom wall or cover of the storage compartment 140.

The illustrated substrate 148 includes at least one outwardly extending (upwardly as viewed in FIG. 8) boss 154. The illustrated boss 154 extends through an aperture 156 in the headliner 144 for attaching the substrate 148 to the headliner 144 of the vehicle. The headliner 144 may include an esthetically pleasing headliner material (not shown) attached to the A-side surface 144A thereof.

The illustrated storage compartment 140 includes a fourth embodiment of the manually deflectable storage compartment closure 146 attached to the substrate 148. The illustrated substrate 148 has a predetermined external contour, the B-side surface 148B of which defines a storage surface. The substrate 148 includes an inwardly facing edge portion 152 (i.e., facing the interior cabin of the vehicle, as viewed in FIG. 8).

An opening 160 of the fourth storage compartment 140 is defined between the edge portion 152 of the substrate 148 and the headliner 144 of the vehicle. It will be understood that the substrate 148 may include an esthetically pleasing headliner material (not shown) attached to the A-side surface 148A thereof.

The illustrated closure 146 includes a mat portion 162 disposed adjacent the B-side surface 148B of the substrate 148, and a closure body 164. The closure body 164 extends inwardly (i.e., toward the interior cabin of the vehicle, as viewed in FIG. 8) and upwardly (i.e., toward the headliner 144, as viewed in FIG. 8) over the opening 160. In the exemplary embodiment illustrated in FIG. 8, the mat portion 162 and the body 164 are attached to the B-side surface 148B of the substrate 148. If desired, the body 164 may extend upwardly (as viewed in FIG. 8) to the headliner 144.

The B-side surface 146B (i.e., the surface facing away from the interior cabin of the vehicle, as viewed in FIG. 8) of the closure 146 may include at least one strengthening or reinforcing rib 166. The size, thickness, and angle A1 (relative to the upwardly extending portion 164) of an upwardly facing (as viewed in FIG. 8) edge surface of the rib 166 may be varied as desired to achieve the desired flexibility and strength. It will therefore be understood that some experimentation may be required to determine the most advantageous angle A1 of the rib 166.

In the illustrated embodiment, the closure 146 is integrally molded to the substrate 148 according to the two-shot molding process described herein above. It will be understood, however, that the method of forming the fourth storage compartment 140 may also be satisfactorily performed wherein the manually deflectable closure 146 is formed prior to the substrate 148.

In another embodiment of the storage compartment 140, the mat portion 162 and the closure body 164 may be formed as a separate components separated by a space (as indicated by the phantom line 165 in FIG. 8).

In the illustrated embodiment, the mat portion 162 and the closure body 164 are formed from any desired material having anti-buzz, squeak, and rattle (BSR) properties. Examples of such material include TPE, TEEE, EPDM, and thermoplastic vulcanate (TPV). It will be understood that any other desired materials, such as other elastomers and non-elastomers, may be used.

In operation, the illustrated storage compartment closure 146 is manually deflectable from a closed position, as shown in FIG. 8, to an open position, as shown generally by the phantom line 164′ in FIG. 8, upon application of a first force (in the direction of the arrow 168) by a vehicle occupant. Such a force may be applied when inserting or removing an object, such as sunglasses, a map, a flashlight, and the like, into or from the storage compartment 140.

The manually deflectable closure 146 then resiliently returns, in a spring-like manner, to the closed position (and thereby to the predetermined exterior contour) upon removal of the applied force or upon application of a second force (in the direction of the arrow 170) and without permanent deformation of the closure 146. The manually deflectable closure 146 allows the vehicle occupant easy access to the storage compartment 140, and provides an efficient, easy to manufacture, and inexpensive cover or closure 146 for the storage compartment 140.

Referring now to FIG. 9, and using like reference numbers to indicate corresponding parts, there is illustrated an elevational view in section, of a portion of a fifth embodiment of the storage compartment, indicated generally at 172. As shown therein, the storage compartment 172 includes a fifth embodiment of manually deflectable storage compartment closure 174 attached to the substrate 176. The illustrated substrate 176 has a predetermined external contour and includes an A-side surface 176A, a B-side surface 176B, and an edge portion 178.

In the illustrated embodiment, the substrate 176 includes a visor bumper portion 177 for engaging a surface 142A (upwardly facing as viewed in FIG. 9) of the visor 142. If desired, the visor bumper portion 177 may be formed from a material having anti-BSR properties, as described in detail herein above. A visor bumper portion 177 having such anti-BSR properties therefore significantly reduces or eliminates undesirable buzzing, squeaking, and/or rattling due to the visor 142 engaging the substrate 176 as illustrated in FIG. 9.

In the illustrated embodiment, the storage compartment 172 includes the recess 143 formed in the headliner 144. An opening 182 of the storage compartment 172 is defined between the edge portion 178 of the substrate 176 and the headliner 144 of the vehicle.

The illustrated closure 174 includes a mat portion 184 disposed adjacent the B-side surface 176B of the substrate 176, and a closure body 186. The closure body 186 extends inwardly (i.e., toward the interior cabin of the vehicle, as viewed in FIG. 9) and upwardly (i.e., toward the overhead substrate 144, as viewed in FIG. 9) over the opening 182. In the exemplary embodiment illustrated in FIG. 9, the mat portion 184 is attached to the B-side surface 176B of the substrate 176. If desired, the closure body 186 may extend upwardly to the headliner 144.

The B-side surface 174B (i.e., the surface facing away from the interior cabin of the vehicle, as viewed in FIG. 9) of the closure 174 includes at least one strengthening or reinforcing rib 188. The size, thickness, and angle A2 (relative to the upwardly extending portion 186) of an upwardly facing (as viewed in FIG. 9) edge surface of the rib 188 may be varied as desired to achieve the desired flexibility and strength, such as shown at 188′.

In the illustrated embodiment, the closure 174 is integrally molded to the substrate 176 according to the two-shot molding process described herein above. It will be understood, however, that the method of forming the fifth storage compartment 172 may also be satisfactorily performed wherein the manually deflectable closure body 184 is formed prior to the substrate 176. Although not illustrated, the mat portion 184 and the closure body 186 may be formed as a separate components separated by a space.

In operation, the illustrated storage compartment closure 174 is manually deflectable from a closed position, as shown in FIG. 9, to an open position, as shown generally by the phantom line 186′ in FIG. 9, upon application of a first force (in the direction of the arrow 190) by a vehicle occupant.

The manually deflectable closure 174 then resiliently returns, in a spring-like manner, to the closed position upon removal of the applied force or upon application of a second force (in the direction of the arrow 192) and without permanent deformation of the closure 174.

The embodiments of the trim component closure disclosed herein have been described as having either having one or two cover members or closures. It will be understood however, that the trim component closures may be formed having any desired number of cover members or closures, such as for example three or more cover members or closures.

The method of forming a trim panel, such as the vehicle door panel 10, the pillar cover 78, the substrate 148, or the substrate 176, having a manually deflectable closure, such as the closures 36, 74, 146, and 174, respectively, as described herein, and the trim panels formed thereby, is advantageous over prior art designs. The method of forming the trim panel 10, 78, 148, and 176 is advantageous because the two-shot molding process eliminates the manual assembly of a closure and a panel, such as a door panel, required by the prior art methods, and provides a low cost substantially flexible or manually deflectable closure for storage compartments or bins that would otherwise have no closure.

The principle and mode of operation of the vehicle trim component and its method of manufacture have been described in its various embodiments. However, it should be noted that the vehicle trim component and its method of manufacture may be practiced otherwise than as specifically illustrated and described without departing from its scope.

What is claimed is:

1. A vehicle trim component comprising:
a substrate defining at least one wall of a storage compartment, said substrate having an edge surface, said edge surface defining an opening into said storage compartment; and
a semi-rigid member extending outward of said edge surface and at least partially covering said opening to define a storage compartment closure, said semi-rigid member being manually deflectable between a closed position and an open position.

2. The vehicle trim component according to claim 1, wherein said semi-rigid member has a structure allowing said semi-rigid member to be manually deflected between said closed position and said open position such that no portion of said semi-rigid member is permanently deformed during said manual deflection.

3. The vehicle trim component according to claim 1, wherein said semi-rigid member is manually deflectable to said open position upon application of a first force by a vehicle occupant, said semi-rigid member resiliently returning to said closed position upon application of a second force by the vehicle occupant.

4. The vehicle trim component according to claim 1, wherein said semi-rigid member is manually deflectable to said open position upon application of a force by a vehicle occupant, said semi-rigid member resiliently returning to said closed position upon removal of said force by the vehicle occupant.

5. The vehicle trim component according to claim 1, wherein a portion of said flexible member forms a living hinge.

6. The vehicle trim component according to claim 1, wherein said semi-rigid member has a predetermined external contour.

7. The vehicle trim component according to claim 6, wherein said semi-rigid member is manually deflectable to said open position upon application of a first force by a vehicle occupant, said semi-rigid member resiliently returning to said closed position and said predetermined external contour upon application of a second force by the vehicle occupant.

8. The vehicle trim component according to claim 6, wherein said semi-rigid member is manually deflectable to said open position upon application of a force by a vehicle occupant, said semi-rigid member resiliently returning to said closed position and said predetermined external contour upon removal of said force by the vehicle occupant.

9. The vehicle trim component according to claim 1, wherein said semi-rigid member includes at least one reinforcing rib extending outwardly from a surface thereof.

10. The vehicle trim component according to claim 1, wherein said semi-rigid member is integrally molded within said opening.

11. A method of forming a vehicle trim component, the method comprising the steps of:
a. forming a substrate within a mold assembly, the substrate being formed from a first material and defining at least one wall of a storage compartment, the substrate having an edge surface which defines an opening into the storage compartment; and
b. forming a semi-rigid member within the mold assembly, the semi-rigid member being formed from a second material different from the first material and extending outward of the edge surface and at least partially covering the opening, the semi-rigid member being manually deflectable between a closed position and an open position and defining a storage compartment closure, thereby forming a vehicle trim component.

12. The method according to claim 11, further including the step of:
c. installing the vehicle trim component in a vehicle such that the storage compartment closure faces the vehicle interior, the semi-rigid member having a structure allowing the semi-rigid member to be manually deflected between the closed position and the open position such that no portion of the semi-rigid member is permanently deformed during the manual deflection.

13. The method according to claim 11, wherein the semi-rigid member is manually deflectable to the open position upon application of a first force by a vehicle occupant, the semi-rigid member resiliently returning to the closed position upon application of a second force by the vehicle occupant.

14. The method according to claim 11, wherein the semi-rigid member is manually deflectable to the open position upon application of a force by a vehicle occupant, the semi-rigid member resiliently returning to the closed position upon removal of the force by the vehicle occupant.

15. The method according to claim 11, wherein the step of forming a semi-rigid member further includes forming a living hinge in a portion of the flexible member.

16. The method according to claim 11, wherein the semi-rigid member is formed having a predetermined external contour.

17. The method according to claim 16, wherein the semi-rigid member is manually deflectable to the open position upon application of a first force by a vehicle occupant, the semi-rigid member resiliently returning to the closed position and the predetermined external contour upon application of a second force by the vehicle occupant.

18. The method according to claim 16, wherein the semi-rigid member is manually deflectable to the open position upon application of a force by a vehicle occupant, the semi-rigid member resiliently returning to the closed position and the predetermined external contour upon removal of the force by the vehicle occupant.

19. The method according to claim 11, wherein the semi-rigid member is formed having at least one reinforcing rib extending outwardly from a surface thereof.

20. A vehicle trim component comprising:
a substrate defining at least one wall of a storage compartment, said wall having an edge surface; and
a semi-rigid member extending outward of said edge surface to define a storage compartment closure, said semi-rigid member being manually deflectable between a closed position and an open position, wherein said semi-rigid member is manually deflectable to said open position upon application of a first force by a vehicle occupant, said semi-rigid member resiliently returning to said closed position upon application of a second force by the vehicle occupant, and wherein a portion of said flexible member forms a living hinge.
